(19) United States
(12) Patent Application Publication
(10) Pub. No.: US 2015/0378472 A1
(43) Pub. Date: Dec. 31, 2015

(54) TOUCH SENSING DISPLAY AND SENSING METHOD THEREOF

(71) Applicant: Innolux Corporation, Chu-Nan (TW)

(72) Inventors: Gerben Johan HEKSTRA, Chu-Nan (TW); Akihiro IWATSU, Chu-Nan (TW); Sheng-Feng HUANG, Chu-Nan (TW)

(73) Assignee: Innolux Corporation, Chu-Nan (TW)

(21) Appl. No.: 14/493,317

(22) Filed: Sep. 22, 2014

Related U.S. Application Data
(60) Provisional application No. 62/016,719, filed on Jun. 25, 2014.

(51) Int. Cl. G06F 3/044

(52) U.S. Cl. CPC G06F 3/044

(57) ABSTRACT

A touch sensing display and a sensing method thereof are provided. The touch sensing display includes a touch sensor layer and an active shield layer. The active shield layer includes a plurality of gate lines and a common electrode. The sensing method comprises the following steps. A touch sensing signal is applied to the touch sensor layer during a touch mode period. A gate signal of the gate lines is controlled to be synchronous to the touch sensing signal during the touch mode period. A common signal of the common electrode is controlled to be synchronous to the touch sensing signal during the touch mode period.

This application claims the benefit of U.S. provisional application Ser. No. 62/016,719, filed Jun. 25, 2014, the subject matter of which is incorporated herein by reference.

### TECHNICAL FIELD

The disclosure relates in general to an electronic device and a controlling method thereof, and more particularly to a touch sensing display and a sensing method thereof.

### BACKGROUND

As the development of the display technology, various display devices have been invented. Some display devices include a display panel and a touch panel. The touch panel is disposed on the display panel. User can touch the items shown on the display panel to input some signal.

For reducing the size the display device, a touch on display (TOD) technology is invented. In the TOD technology, the touch panel and the display panel are integrated into one piece. That is to say, some of the elements in the display panel are worked for the touch function. However, because the touch panel and the display panel are integrated into one piece, the detection of the touch is easily to be interfered.

### SUMMARY

The disclosure is directed to a touch sensing display and a sensing method thereof. A gate signal and a common signal are controlled to be synchronous to a touch sensing signal during a touch mode period. Therefore, a finger can be accurately detected without any interference.

According to one embodiment, a sensing method for a touch sensing display is provided. The touch sensing display includes a touch sensor layer and an active shield layer wherein the active shield layer is also an active area array of the touch sensing display. The active shield layer includes a plurality of gate lines and a common electrode. The sensing method comprises the following steps. A touch sensing signal is applied to the touch sensor layer during a touch mode period. A gate signal of the gate lines is controlled to be synchronous to the touch sensing signal during the touch mode period. A common signal of the common electrode is controlled to be synchronous to the touch sensing signal during the touch mode period.

According to another embodiment, a touch sensing display is provided. The touch sensing display includes a touch sensor layer, a touch sensing signal generator, an active shield layer, a gate driver, a common signal driver and a mode controller. The touch sensing signal generator is coupled to the touch sensor layer for applying a touch sensing signal to the touch sensor layer during a touch mode period. The active shield layer includes a plurality of gate lines and a common electrode. The gate driver is for applying a gate signal to the gate lines. The common signal driver is for applying a common signal to the common electrode. The mode controller is for controlling the gate signal to be synchronous to the touch sensing signal during the touch mode period, and controlling the common signal to be synchronous to the touch sensing signal.

### BRIEF DESCRIPTION OF THE DRAWINGS

FIG. 1 shows a touch sensing display.

FIG. 2 shows a touch function layout of the touch sensing display.

FIG. 3 shows an active shield layer of the touch sensing display.

FIGS. 4A to 4C show a frame showing duration according to several embodiments.

FIG. 5 shows a circuit layout of the touch sensing display.

FIG. 6 shows a touch sensing signal, a gate signal, a common signal and a source signal during a touch sensing display mode period and a touch mode period.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

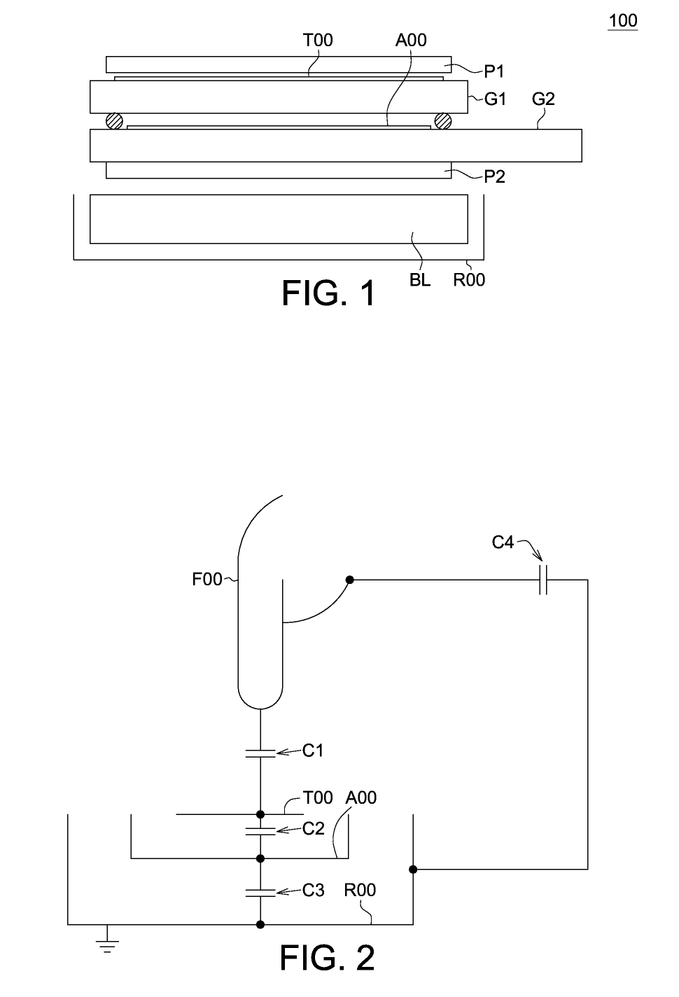

Please referring to FIGS. 1 and 2, FIG. 1 shows a touch sensing display 100, and FIG. 2 shows a touch function layout of the touch sensing display 100. Referring to FIG. 1, the touch sensing display 100 includes a touch sensor layer T00, an active shield layer A00, a reference ground layer R00, a first polarizer P1, a second polarizer P2, a back light module BL, a color filter substrate G1 and a thin film transistor (TFT) substrate G2. The active shield layer is also an active area array of the touch sensing display 100. The back light module BL is used for providing a back light. The first polarizer P1 is disposed above the color substrate G1. The second polarizer P2 is disposed below the TFT substrate G2. A finger F00 (shown in FIG. 2) or a probe can be detected by means of accurate capacitive measurement. Each of the touch sensor layer T00, the active shield layer A00 and the reference ground layer R00 is conductive. The active shield layer A00 can provide shielding for a plurality of sensors in the touch sensor layer T00 at the same time. Non-conductive and dielectric material is disposed among the touch sensor layer T00, the active shield layer A00 and the reference ground layer R060. For example, the non-conductive and dielectric material may be air, glass, or polyethylene terephthalate (PET). Or, each gap among the touch sensor layer T00, the active shield layer A00 and the reference ground layer R00 may be a vacuum space. The effective capacitances form between the touch sensor layer T00, the active shield layer A00 and the reference ground layer R00.

Referring to FIG. 1, the touch sensor layer T00 may be an Indium Tin Oxide (ITO) layer on the color filter substrate G1. In one embodiment, the touch sensor layer T00 may be formed on a PET film or a cover window glass (OGS) located above the color filter glass G1. The active shield layer A00 may be an active area array on the top of the TFT substrate G2. The reference ground layer R00 may be a metal casing.

Referring to FIG. 2, a first capacitance C1 is formed between the finger F00 and the touch sensor layer T00, a second capacitance C2 is formed between the touch sensor layer T00 and the active shield layer A00, and a third capacitance C3 is formed between the active shield layer A00 and the reference ground layer R00. For accurately detecting the finger F00, the value of the first capacitance C1 is needed to be correctly measured without any interference.

Moreover, there is a fourth capacitance C4 formed between the finger F00, connected to the human body, to the reference ground layer R00, via the far field.

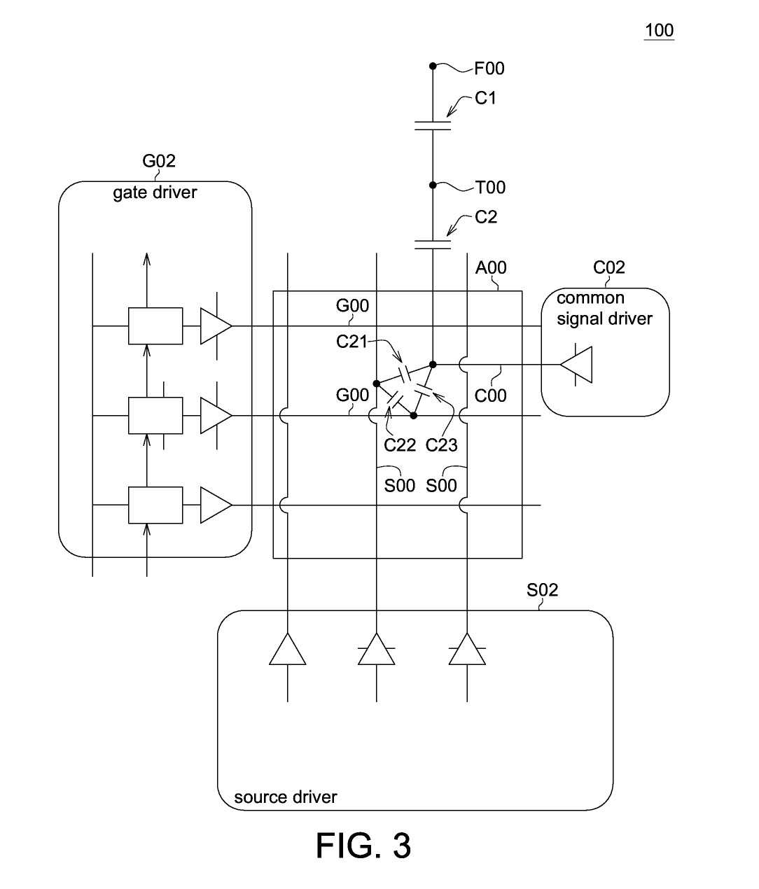

Please refer to FIG. 3, which shows the active shield layer A00 of the touch sensing display 100. The active shield layer A00 includes a plurality of gate lines G00, a plurality of source lines S00 and a common electrode C00. The touch sensing display 100 further includes a gate driver G02, a source driver S02 and a common signal driver C02. The gate driver G02 is used for driving the gate lines G00. The source driver S02 is used for driving the source lines S00. The common signal driver C02 is used for driving the common electrode C00.

Referring to FIG. 3, during a touch mode operation, the pixels in the touch sensing display 100 are not being addressed. With no active elements at work in the array, only passive elements, such as parasitic capacitances are at work. A capacitance C22 is formed between the gate lines G00 and the source line S00. A capacitance C23 is formed between the gate lines G00 and the common electrode C00. A capacitance C21 is formed between the source line S00 and the common electrode C00. The capacitances C21, C22, C23 are relatively large, and connected in a capacitive network together with the second capacitance C2 and the to be measured first capacitance C1. During a touch sensing mode, care must be taken to apply proper signals on the gate lines G00, the source lines S00, and the common electrode C00, such that the capacitances C21, C22, C23 have little or no influence on the measurement of the first capacitance C1.

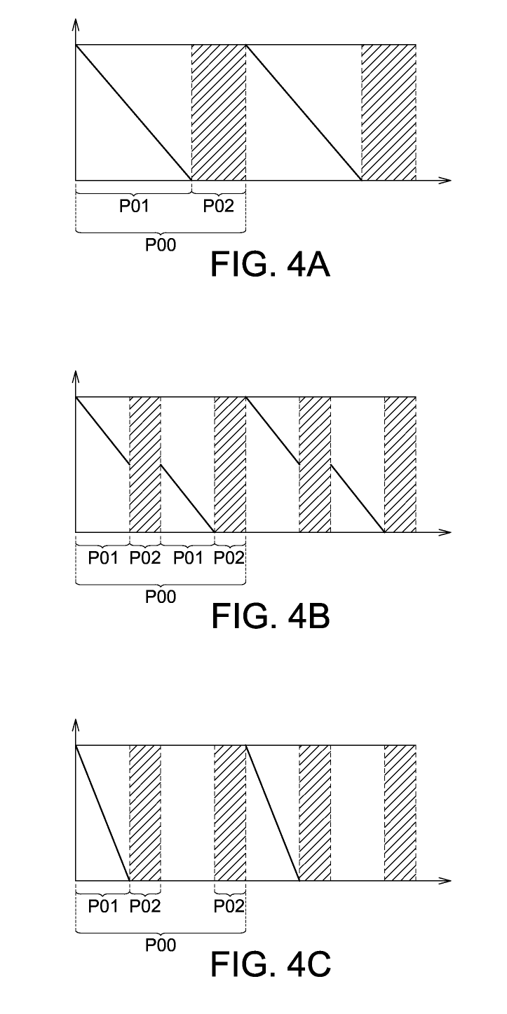

Please refer to FIGS. 4A to 4C, which show the addressing timing of each frame according to several embodiments. The duration P00 of each frame includes a display mode period P01 (i.e. addressing time) and a touch mode period P02 (i.e. blanking time). In the display mode period P01, the touch sensing display 100 scans line-by-line to show a frame. In the touch mode period P02 where no scanning takes place, the frame is kept on the screen and the touch function is activated. In each frame showing duration P00 of FIG. 4A, the number of the display mode period P01 is one and the number of the touch mode period P02 is one.

In each frame showing duration P00 of FIG. 4B, the number of the display mode period P01 is two and the number of the touch mode period P02 is two. In each display mode period P01, half of the screen is scanned.

In each frame showing duration P00 of FIG. 4C, the number of the display mode period P01 is one and the number of the touch mode period P02 is two. In each display mode period P01, whole of the screen is scanned and the scanning rate is faster than that of the FIGS. 4A and 4B.

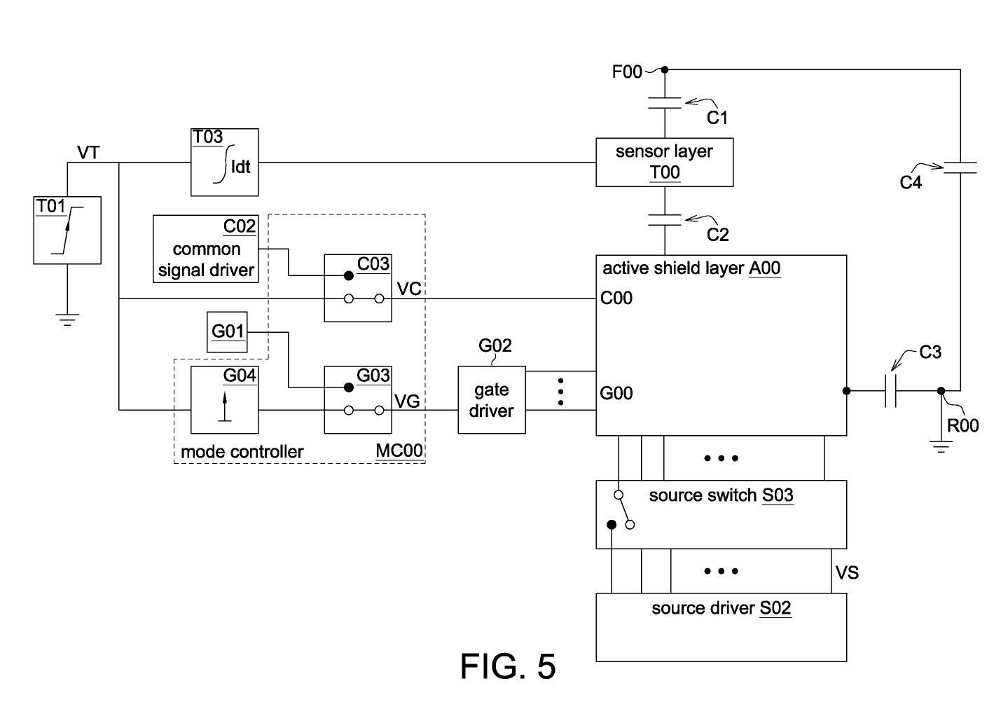

Please referring to FIG. 5, FIG. 5 shows a circuit layout of the touch sensing display 100. A touch sensing signal generator T01 which can create voltage step coupled to the touch sensor layer T00 is used for applying the touch sensing signal VT. The gate driver G02 coupled to active shield layer A00 is used for applying a gate signal VG to the gate lines G00 (shown in FIG. 3). The common signal driver C02 coupled the active shield layer A00 is used for applying a common signal VC to the common electrode C00 (shown in FIG. 3). The source driver S02 coupled to the active shield layer A00 is used for applying a source signal VS to the source lines S00 (shown in FIG. 3).

The mode controller MC00 which controlling handover between the touch sensing mode and a display addressing mode includes a gate switch G03, an offsetting unit G04 and a common signal switch C03. The touch sensing display 100 further includes a gate signal generator G01, a common signal generator C01, a source switch S03 and a touch charge integrator T03.

During the display mode period P01, the gate switch G03 connects the gate signal generator G01 and the gate driver G02. The gate signal generator G01 provides the gate signal VG to the gate driver G02. The voltage level of the gate signal VG is controlled, such that the selected TFTs in the active area array remained in a GATE OFF state. In the display addressing mode, this level is chosen as −8V for a LTPS process, and is provided by the gate driver G02 to all gate lines G00 which are not being addressed. The common signal switch C03 connects the common signal generator C01 and the common signal driver C02. The source switch S03 connects the source driver S02 and the source lines S00 (shown in FIG. 3).

During the touch mode period P02, the touch sensing signal generator T01 applies the touch sensing signal VT to the sensor layer T00. The touch charge integrator T03 is used for analyzing the charge of the first capacitance C1 to detect the finger F00 or the probe touching. The gate switch G03 connects the offsetting unit G04 and the gate driver G02. The offsetting unit G04 is used for offsetting the touch sensing signal VT. And via the offsetting unit G04, the voltage level of the gate signal VG can vary between −6V and −10V for the same LTPS process, and is provided by the gate driver G02 to all gate lines G00. The common switch C03 connects the touch sensing signal generator T01 and the common signal driver C02. The source switch S03 disconnects the source driver S02 and the source lines S00 (shown in FIG. 3).

As such, during the touch mode period P02, the mode controller MC00 controls the gate signal VG to be synchronous to the touch sensing signal VT, the mode controller MC00 controls the common signal VC to be synchronous to the touch sensing signal VT, and the source switch S02 controls the source lines S00 to be floating. As such, with the gate signals VG and the common signal VC being synchronous, and equal in amplitude to the touch sensing signal VT, the sensor layer T00, and the active shield layer A00, comprising the common electrode C00, the gate lines G00,and the source lines S00, all experience are the same, and have identical voltage step. This causes that there is no current flowing between the sensor layer T00, and the active shield layer A00, and ensures that the parasitic capacitances, such as the second capacitance C2, and the capacitances C21, C22, C23, have no influence on the measurement of the first capacitance C1.

In one embodiment, the gate switch G03, the offsetting unit G01 and the common signal switch C03 of the mode controller MC00 are integrated into a display driver integrated chip. The source switch S03 is disposed on the TFT substrate G2 (shown in FIG. 1).

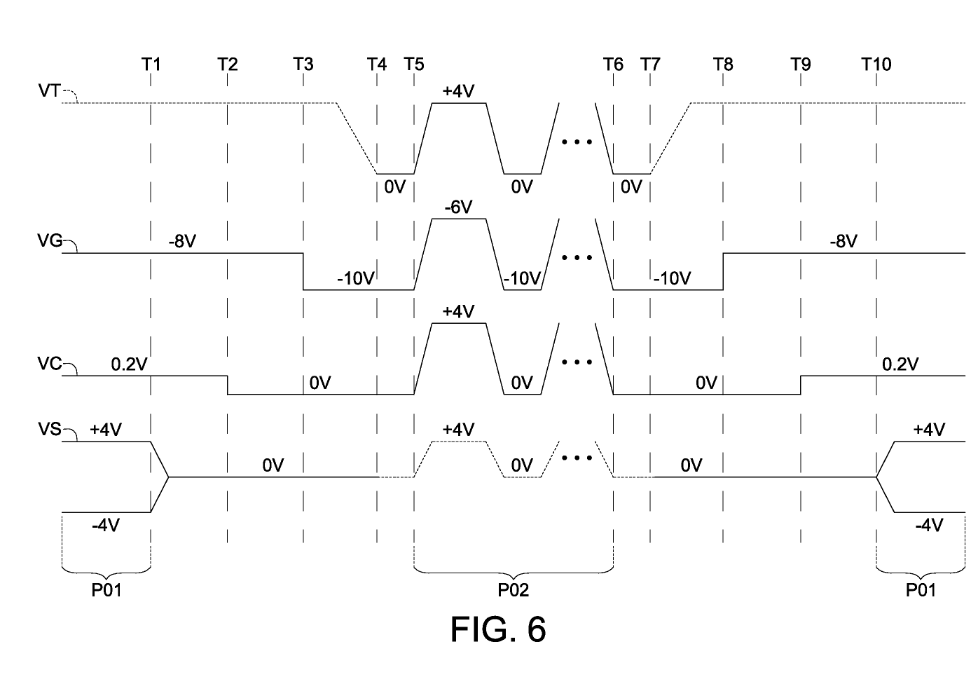

Please referring to FIG. 6, which shows the touch sensing signal VT, the gate signal VG, the common signal VC and the source signal VS during the display mode period P01 and the touch mode period P02. Before the time T1, the touch sensing display 100 is at the display mode period P01. The touch sensing display 100 is scanned line-by-line to show a frame.

At the time T1, a transition from the display mode P01 to the touch mode period P02 is now starting. The source signal VS is driven to be a predetermined value within a source signal range. For example, the source signal VS may be driven to be 0V.

At the time T2, the common signal VC is driven to be a predetermined value which is a low level of the touch sensing signal VS, such as 0V.

At the time T3, the gate signal VG is driven to be a predetermined value which is offset from the low level of the touch sensing signal VT, such as −10V.

At the time T4, the source signal VS is controlled to be floating and will follow the gate signal VG and the common signal VC.

At the time T5, the touch sensing signal VT is applied to the touch sensor layer T00. The touch sensing signal VT is a cyclic wave.

During the touch mode period P01, the gate signal VG and the common signal VC are controlled to be synchronous to the touch sensing signal VT. For example, a cycle of the touch sensing signal VT, a cycle of the gate signal and a cycle of the common signal VC are identical and an amplitude of the touch sensing signal VT, an amplitude of the gate signal and an amplitude of the common signal VC are 4V. Besides, during touch operation, in order to keep the pixel values of the active area array not affected, the minimum and maximum levels of the gate signal VG is controlled, such that the TFT devices in the active area array remain OFF. So the gate signal VG must be in the allowable range of the TFT devices gate voltage to keep the TFT devices in the active area array remain OFF. For example, the minimum of the gate signal VG is −10V and the maximum of the gate signal VG is −6V, if an amplitude of the touch sensing signal VT is 4V (−10 v+4V=−6V).

At the time T6, a transition from the touch mode P02 to the display mode period P01 is now starting. The touch sensing signal VT is controlled to be 0V, the gate signal VG is controlled to be −10V, and the common signal VC is controlled to be 0V.

At the time T7, the source switch S03 connects the source lines S00 and the source driver S02. The source lines S00 are driven to be a predetermined voltage within the source signal range. For example, the source lines S00 may be driven to be 0V.

At the time T8, the gate signal VG is controlled to be regular gate-off voltage level, such as −8V.

At the time T9, the common signal VC is controlled to be display VCOM level which setting to minimize flicker, such as 0.2V.

At the time T10, the touch sensing display 100 is at the display mode period P01.

Base on above, during the touch mode period, the gate signal VG and the common signal VC are controlled to be synchronous to the touch sensing signal VT during the touch mode period P02. The value of the first capacitance C1 will not be interfered by the active shield layer A00, and the finger F00 can be accurately detected.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A sensing method for a touch sensing display, wherein the touch sensing display includes a touch sensor layer and an active shield layer, the active shield layer includes a plurality of gate lines and a common electrode, and the sensing method comprises:
applying a touch sensing signal to the touch sensor layer during a touch mode period;
controlling a gate signal of the gate lines to be synchronous to the touch sensing signal during the touch mode period; and
controlling a common signal of the common electrode to be synchronous to the touch sensing signal during the touch mode period.

2. The sensing method according to claim 1, wherein a cycle of the gate signal, a cycle of the common signal and a cycle of the touch sensing signal are controlled to be identical.

3. The sensing method according to claim 1, wherein an amplitude of the gate signal, an amplitude of the common signal and an amplitude of the touch sensing signal are controlled to be identical.

4. The sensing method according to claim 1, wherein the active shield layer further includes a plurality of source lines, and the source lines are controlled to be floating during the touch mode period.

5. A touch sensing display, comprising:
a touch sensor layer;
a touch sensing signal generator coupled to the touch sensor layer for applying a touch sensing signal to the touch sensor layer during a touch mode period;
an active shield layer, including:
a plurality of gate lines; and
a common electrode;
a gate driver for applying a gate signal to the gate lines;
a common signal driver for applying a common signal to the common electrode; and
a mode controller for controlling the gate signal to be synchronous to the touch sensing signal, and controlling the common signal to be synchronous to the touch sensing signal during the touch mode period.

6. The touch sensing display according to claim 5, wherein the mode controller controls a cycle of the gate signal and a cycle of the common signal to be identical to a cycle of the touch sensing signal.

7. The touch sensing display according to claim 5, wherein the mode controller controls an amplitude of the gate signal and an amplitude of the common signal to be identical to an amplitude of the touch sensing signal.

8. The touch sensing display according to claim 5, wherein the active shield layer further includes a plurality of source lines, and the touch sensing display further comprises:
a source driver for applying a source signal to the source lines; and
a source switch coupled between the source lines and the source driver and selected to leave the source lines floating during the touch mode period.

9. The touch sensing display according to claim 5, wherein the mode controller includes a gate switch coupled between the gate lines and the touch sensing signal generator.

10. The touch sensing display according to claim 9, wherein the mode controller includes an offsetting unit coupled between the touch sensing signal generator and the gate switch, and the offsetting unit is for offsetting the touch sensing signal.

11. The touch sensing display according to claim 5, wherein the mode controller includes a common signal switch coupled between the common electrode and the touch sensing signal generator.
